(19) United States
(12) Patent Application Publication
(10) Pub. No.: US 2025/0066577 A1
(43) Pub. Date: Feb. 27, 2025

(54) COMPOSITE FLAME RETARDANTS, PREPARATION METHOD THEREOF, ELASTIC SHEET FOR ALL-SOLID-STATE RECHARGEABLE BATTERIES AND ALL-SOLID-STATE RECHARGEABLE BATTERIES

(71) Applicant: SAMSUNG SDI CO., LTD., Yongin-si (KR)

(72) Inventors: Changhee WOO, Yongin-si (KR); Ik-Hwan Cho, Yongin-si (KR); Jiwan You, Yongin-si (KR); Jinhwan Park, Yongin-si (KR); Young Gyoon Ryu, Yongin-si (KR)

(21) Appl. No.: 18/805,712

(22) Filed: Aug. 15, 2024

(30) Foreign Application Priority Data
Aug. 25, 2023 (KR) 10-2023-0112175

(51) Int. Cl. C08K 3/02; C08F 20/14; C08G 71/04; C08K 9/04

(52) U.S. Cl. CPC C08K 3/02; C08F 20/14; C08G 71/04; C08K 9/04; C08K 2003/026; C08K 2201/003

(57) ABSTRACT

A composite flame retardant for an all-solid-state rechargeable battery, the composite flame retardant includes core particles including a phosphorus flame retardant; and a coating layer on a surface of the core particles, the coating layer including a melamine flame retardant, wherein the coating layer has a thickness of less than or equal to about 1 μm.

### CROSS-REFERENCE TO RELATED APPLICATION

This application claims priority to and the benefit of Korean Patent Application No. 10-2023-0112175 filed in the Korean Intellectual Property Office on Aug. 25, 2023, the entire contents of which are incorporated herein by reference.

### BACKGROUND

### 1. Field

Embodiments relate to composite flame retardants for an all-solid-state rechargeable battery, preparation methods thereof, elastic sheets for all-solid-state rechargeable batteries including the same, and all-solid-state rechargeable batteries.

### 2. Description of the Related Art

A portable information device such as a cell phone, a laptop, smart phone, or the like or an electric vehicle may use a rechargeable lithium battery having high energy density and easy portability as a driving power source. Recently, research has been actively conducted to use a rechargeable lithium battery with high energy density as a driving power source or power storage power source for hybrid or electric vehicles.

### SUMMARY

The embodiments may be realized by providing a composite flame retardant for an all-solid-state rechargeable battery, the composite flame retardant including core particles including a phosphorus flame retardant; and a coating layer on a surface of the core particles, the coating layer including a melamine flame retardant, wherein the coating layer has a thickness of less than or equal to about 1 μm.

An average particle diameter (D₅₀) of the core particles may be about 5 μm to about 30 μm.

The phosphorus flame retardant may include a phosphate, a phosphite, a phosphonate, a phosphinate, a phosphine oxide, or a combination thereof.

The phosphorus flame retardant may include ammonium phosphate, ammonium polyphosphate, trimethyl phosphate, triethyl phosphate, tripropyl phosphate, tripentyl phosphate, tris(2-ethylhexyl)phosphate, trioctyl phosphate, tris(2-butoxyethyl) phosphate, tris(2-chloroethyl) phosphate, tris(1-chloro-2-propyl) phosphate, tris(2-chloropropyl) phosphate, tris(3-chloropropyl) phosphate, tris(1,3-dichloro-2-propyl) phosphate, tris(2,3-dibromopropyl) phosphate, tris(tribromoneopentyl) phosphate, trimethylpropane methylphosphinic oligomer, pentaerythritol phosphate, cyclic neopentyl thio phosphoric anhydride, 2-ethylhexyl diphenyl phosphate, isodecyl diphenyl phosphate, dodecyl diphenyl phosphate, triphenyl phosphate, cresyl diphenyl phosphate, tricresyl phosphate, trixylenyl phosphate, xylenyl diphenyl phosphate, tert-butylphenyl diphenyl phosphate, phenyl di(isopropylphenyl) phosphate, tris(2,4-dibromophenyl) phosphate, N,N′-bis(2-hydroxyethyl) aminomethyl phosphate, resorcinol bis(diphenyl phosphate), phenyl diresorcinyl phosphate, bisphenol A bis(diphenyl phosphate), tetraphenyl m-p-phenylene diphosphate, tetrakis(2-chloroethyl)dichloroisopentyl diphosphate, dimethyl propane phosphonate, dimethyl methane phsophonate, diethyl ethane phsophonate, diethyl hydroxymethyl phsophonate, aluminum diethyl phosphinate, zinc diethyl phosphinate, aluminum dipropyl phosphinate, aluminum 2-carboxyethyl phenyl phosphinate, aluminum hypophosphite, or a combination thereof.

The coating layer may have a thickness of about 10 nm to about 900 nm.

The coating layer may be in a form of a continuous film or an island.

The melamine flame retardant may include melamine, melamine cyanurate, melamine phosphate, melamine pyrophosphate, melamine polyphosphate, or a combination thereof.

A ratio of a thickness of the coating layer to a diameter of the core particle may be about 0.01 to about 0.1.

An average particle diameter (D₅₀) of the composite flame retardant may be about 5 μm to about 31 μm.

A weight ratio of the phosphorus flame retardant of the core particle and the melamine flame retardant of the coating layer may be about 65:35 to about 95:5.

The embodiments may be realized by providing a method for preparing a composite flame retardant for an all-solid-state rechargeable battery, the method including mixing a phosphorus flame retardant and a melamine flame retardant in a solvent at a weight ratio of about 65:35 to about 95:5 to prepare a mixture; and filtering and drying the mixture to obtain a composite flame retardant that includes core particles including a phosphorus flame retardant and a coating layer on a surface of the core particles, the coating layer including a melamine flame retardant.

The solvent may be an aqueous solvent including water, alcohol, or a combination thereof.

Mixing the phosphorus flame retardant and the melamine flame retardant in a solvent may be performed for about 10 minutes to about 6 hours at a temperature range of about 40° C. to about 120° C.

Mixing the phosphorus flame retardant and the melamine flame retardant in a solvent may include preparing a first solution in which the phosphorus flame retardant is dispersed in a solvent, preparing a second solution in which a melamine flame retardant is dispersed in a solvent, and dropping a first solution into the second solution and stirring.

The drying may be performed in a temperature range of about 80° C. to about 180° C.

The embodiments may be realized by providing an elastic sheet for an all-solid-state rechargeable battery, the elastic sheet including a polymer resin, and the composite flame retardant according to an embodiment.

The polymer resin may include a urethane resin, an acrylic resin, a silicone resin, a fluorine resin, a copolymer thereof, or a mixture thereof.

The composite flame retardant may be included in an amount of about 1 part by weight to about 60 parts by weight, based on 100 parts by weight of the polymer resin.

A thickness of the elastic sheet may be about 100 μm to about 2,000 μm.

A thickness of the elastic sheet may be about 100 μm to about 300 μm.

The elastic sheet may be in a form of a foam rubber.

The embodiments may be realized by providing an all-solid-state rechargeable battery including two or more cell structures, each including a positive electrode, a negative electrode, and a solid electrolyte layer between the positive electrode and negative electrode, and elastic sheets between the two or more cell structures and at an outermost layer, wherein at least one of the elastic sheets includes the composite flame retardant according to an embodiment.

The embodiments may be realized by providing an all-solid-state rechargeable battery including a cell structure including a positive electrode, a negative electrode, and a solid electrolyte layer between the positive electrode and negative electrode, and a resin layer on a side of the cell structure, wherein the resin layer includes a resin and the composite flame retardant according to an embodiment.

### BRIEF DESCRIPTION OF THE DRAWINGS

Features will be apparent to those of skill in the art by describing in detail exemplary embodiments with reference to the attached drawings in which:

FIGS. 1 to 3 are cross-sectional views schematically showing all-solid-state rechargeable batteries according to some embodiments.

FIG. 4 is a scanning electron microscope (SEM) image of aluminum diethyl phosphinate (ADP) particles corresponding to the core particles in the composite flame retardant of Example 1.

FIG. 5 is an SEM image of melamine cyanurate (MC) used as a coating layer material in the composite flame retardant of Example 1.

FIG. 6 is an SEM image of the composite flame retardant prepared in Example 1.

FIG. 7 is a thermogravimetric analysis (TGA) graph for each of the composite flame retardant of Example 1, the flame retardant of Comparative Example 2, ADP, and MC.

FIG. 8 is a Fourier Transform Infrared Spectroscopy (FT-IR) graph for the composite flame retardant of Example 1, ADP, and MC, respectively.

FIGS. 9 to 11 are SEM images of the cross-section of the elastic sheet manufactured in Comparative Example 2.

FIGS. 12 to 14 are SEM images of the cross-section of the elastic sheet manufactured in Example 1.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In addition, it will also be understood that when a layer is referred to as being “between” two layers, it can be the only layer between the two layers, or one or more intervening layers may also be present. Like reference numerals refer to like elements throughout. The singular expression includes the plural expression unless the context clearly dictates otherwise.

As used herein, “combination thereof” means a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but do not preclude the possibility of the presence or addition of one or more other features, number, step, element, or a combination thereof.

In the drawings, the thickness of layers, films, panels, regions, etc., may be exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

In addition, the average particle diameter may be measured by a method well known to those skilled in the art, for example, by using a particle size analyzer, or by using a transmission electron microscopic image or a scanning electron microscopic image. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D₅₀) of particles having a cumulative volume of 50 volume % in the particle size distribution. As used herein, when a definition is not otherwise provided, the average particle diameter means a diameter (D₅₀) of particles having a cumulative volume of 50 volume % in the particle size distribution that is obtained by measuring the size (diameter or length of the long axis) of about 20 particles at random in a scanning electron microscopic image. Herein, “or” is not to be construed as an exclusive meaning, for example, “A or B” is construed to include A, B, A+B, and the like.

“Metal” is interpreted as a concept including ordinary metals, transition metals and metalloids (semi-metals).

### Composite Flame Retardant

The composite flame retardant according to some embodiments may include core particles including a phosphorus flame retardant, and a coating layer on a surface of the core particles and including a melamine flame retardant. In an implementation, the coating layer may have a thickness of, e.g., less than or equal to about 1 μm.

Some halogen flame retardants may be used for industrial purposes, but halogen flame retardants are subject to environmental regulations and their use is restricted due to the risk of generating toxic chemicals such as halogenated hydrogen gas.

Phosphorus flame retardants may be environmentally friendly flame retardants that can provide excellent flame retardant effects when added to resins, and may be used as substitutes for halogen flame retardants. Phosphorus flame retardants could have limitations, e.g., not having excellent interfacial characteristics and the possibility of volatilization when introduced to materials such as urethane, acrylic resin, silicone resin, and the like.

The composite flame retardant according to some embodiments may be a composite flame retardant manufactured by, e.g., wrapping the phosphorus flame retardant particles with the melamine flame retardant in a capsule form by using a wet process. First, such a composite flame retardant may have excellent compatibility of the melamine flame retardant of the particle surface with polar resins such as urethane, acrylic resin, silicon, or the like to achieve excellent interfacial characteristics with resins. In addition, it may not be agglomerated but rather may be well dispersed in the resins to help secure excellent processability and even improve flame retardant performance. Second, the composite flame retardant, in which the phosphorus flame retardant is encapsulated with the melamine flame retardant, may help effectively address the volatilization of the phosphorus flame retardant. Third, the composite flame retardant, in which the phosphorus flame retardant and the melamine flame retardant are complexed each other may exert synergistic effects, and may greatly improve the flame retardant performance. In an implementation, thermal decomposition dispersion of the phosphorus flame retardant and melamine may cause a chemical reaction and thus form, e.g., melamine phosphate or the like, which may help improve the flame retardant performance.

The composite flame retardant may be applied to various parts of the all-solid-state rechargeable battery, thereby further improving the fire safety of the all-solid-state rechargeable battery. In an implementation, the composite flame retardant may be applied at various positions or elements, e.g., elastic sheet, resin layer, flame retardant sheet, insulation part, adhesive sheet, positive electrode, negative electrode, or solid electrolyte layer of an all-solid-state rechargeable battery. In an implementation, a resin composition such as urethane, acrylic resin, silicone, or the like may be applied to parts as basic materials.

### Core Particles

The core particles of the composite flame retardant may have an average particle diameter (D₅₀) of about 5 μm to about 30 μm, e.g., about 6 μm to about 29 μm, or about 8 μm to about 28 μm. Herein, the average particle diameter may be obtained by selecting about 20 particles at random in the scanning electron microscopic image of particles, measuring the particle diameter (diameter, long axis, or length of the long axis) to obtain the particle size distribution, and taking the diameter (D₅₀) of particles with a cumulative volume of 50 volume % as the average particle diameter in the particle size distribution.

In an implementation, the core particle may be in the form of a particle, e.g., spherical, elliptical, polyhedral, or shapeless.

The phosphorus flame retardant may include, e.g., a phosphate, a phosphite, a phosphonate, a phosphinate, a phosphine oxide, or a combination thereof. The phosphate, phosphite, phosphonate, phosphinate, and phosphine oxide may have organic functional groups such as an alkyl group, an aryl group, and an alkenyl group, and the organic functional groups may be substituted with a halogen group, an amine group, a hydroxy group, and a thiol group, and the like. In an implementation, the alkyl group may be an alkyl group having 1 to 20 carbon atoms, the aryl group may be an aryl group having 6 to 20 carbon atoms, and the alkenyl group may be an alkenyl group having 2 to 20 carbon atoms. The phosphate may include, e.g., trialkyl phosphate, alkyldiaryl phosphate, triaryl phosphate, ammonium polyphosphate, or the like, and the phosphinate may include, e.g., a metal dialkyl phosphinate.

In an implementation, the phosphorus flame retardant may include, e.g., ammonium phosphate, ammonium polyphosphate, trimethyl phosphate, triethyl phosphate, tripropyl phosphate, tripentyl phosphate, tris(2-ethylhexyl)phosphate, trioctyl phosphate, tris(2-butoxyethyl) phosphate, tris(2-chloroethyl) phosphate, tris(1-chloro-2-propyl) phosphate, tris(2-chloropropyl) phosphate, tris(3-chloropropyl) phosphate, tris(1,3-dichloro-2-propyl) phosphate, tris(2,3-dibromopropyl) phosphate, tris(tribromoneopentyl) phosphate, a trimethylpropane methylphosphinic oligomer, pentaerythritol phosphate, cyclic neopentyl thio phosphoric anhydride, 2-ethylhexyl diphenyl phosphate, isodecyl diphenyl phosphate, cresyl diphenyl phosphate, triphenyl phosphate, tricresyl phosphate, tert-butylphenyl diphenyl phosphate, tris(2,4-dibromophenyl) phosphate, N,N′-bis(2-hydroxyethyl) aminomethyl phosphate, resorcinol bis(diphenyl phosphate), bisphenol A bis(diphenyl phosphate), tetraphenyl m-p-phenylene diphosphate, tetrakis(2-chloroethyl)dichloroisopentyl diphosphate, dimethyl propane phsophonate, dimethyl methane phsophonate, diethyl ethane phsophonate, diethyl hydroxymethane phsophonate, aluminum diethyl phosphinate, zinc diethyl phosphinate, aluminum dipropyl phosphinate, aluminum 2-carboxyethyl phenyl phosphinate, or a combination thereof.

### Coating Layer

The coating layer of the composite flame retardant according to some embodiments may be formed by a wet method, which will be described below, and may have a thickness of, e.g., less than or equal to about 1 μm. In an implementation, the thickness of the coating layer may be, e.g., about 10 nm to about 900 nm, about 50 nm to about 800 nm, or about 100 nm to about 700 nm, and may be on the order of hundreds of nanometers. In an implementation, the thickness of the coating layer can be measured through, e.g., FIB, SEM, TEM, TOF-SIMS, XPS, or EDS analysis. In an implementation, one particle of the composite flame retardant can be milled and broken through FIB, then photographed with an SEM, and the thickness of the coating layer can be measured from the SEM image.

The coating layer may be in the form of a continuous film or may be in the form of an island (e.g., a discontinuous arrangement). In an implementation, it may be formed by a wet method, and the coating layer may exist in the form of an island.

The melamine flame retardant of the coating layer may include melamine, a melamine derivative, or a combination thereof. In an implementation, the melamine flame retardant may include, e.g., melamine, melamine cyanurate, melamine phosphate, melamine pyrophosphate, melamine polyphosphate, or a combination thereof.

In the coating layer, the melamine flame retardant may exist in the form of a particle, and the average particle diameter (D₅₀) of the melamine flame retardant particle may be, e.g., about 0.5 μm to about 5 μm, about 0.5 μm to about 4 μm, or about 0.5 μm to about 2 μm.

### Composite Flame Retardant

In an implementation, the average particle diameter (D₅₀) of the composite flame retardant may be, e.g., about 5 μm to about 21 μm, about 5.5 μm to about 20 μm, about 6 μm to about 19 μm, or about 8 μm to about 18 μm.

A ratio of the thickness of the coating layer to the diameter of the core particle may be about 0.01 to about 0.1, e.g. about 0.02 to about 0.09 or about 0.03 to about 0.08. Within the above ratios, the composite flame retardant may achieve excellent flame retardant performance while effectively suppressing the volatilization of the phosphorus flame retardant and improving compatibility with resin.

A weight ratio of the phosphorus flame retardant of the core particle and the melamine flame retardant of the coating layer may be about 65:35 to about 95:5, e.g., about 70:30 to about 70:10. Within these weight ratios, the composite flame retardant may achieve excellent flame retardant performance while effectively suppressing the volatilization of phosphorus flame retardant and improving compatibility with resin.

### Method of Preparing Composite Flame Retardant

In an implementation, the method of preparing the composite flame retardant may include mixing a phosphorus flame retardant and a melamine flame retardant in a solvent (or dispersant) at a weight ratio of about 65:35 to about 95:5, followed by filtering and drying, to obtain a composite flame retardant including core particles including a phosphorus flame retardant and a coating layer on a surface of the core particles and including a melamine flame retardant. This may be said to be a method of combining two types of flame retardants through a wet process, though which the phosphorus flame retardant may be encapsulated with the melamine flame retardant.

In an implementation, a composite flame retardant manufactured according to the method may contain or exhibit both properties of the phosphorus flame retardant and properties of the melamine flame retardant with reference to the TGA or FT-IR analysis results, e.g., the phosphorus flame retardant and the melamine flame retardant may be complexed or encapsulated each other without changing their own properties, respectively. In an implementation, in the composite flame retardant, the phosphorus flame retardant of the core and the melamine flame retardant of the coating layer may be bonded through hydrogen bonding or the like, or may be physically bonded.

The solvent may be an aqueous solvent including, e.g., water, alcohol, or a combination thereof.

In the solvent, the phosphorus flame retardant and the melamine flame retardant may be mixed in a weight ratio of about 65:35 to about 95:5, e.g., about 70:30 to about 90:10. Within the weight ratio ranges, a composite flame retardant realizing excellent flame retardant performance, effectively suppressing the volatility of the phosphorus flame retardant, and exhibiting improved compatibility with the resin may be prepared.

The mixing of the phosphorus flame retardant and the melamine flame retardant in the solvent may be performed, e.g., at temperature range of about 40° C. to about 120° C. or about 60° C. to about 100° C. for about 10 minutes to about 6 hours or about 1 hour to 3 about hours.

In an implementation, the mixing of the phosphorus flame retardant and the melamine flame retardant in the solvent may include (i) preparing a first solution (or dispersion) by dispersing the phosphorus flame retardant in the solvent (or dispersant), (ii) preparing a second solution (or dispersion) by dispersing the melamine flame retardant in the solvent (or dispersant), and (iii) adding first solution to the second solution in a dropwise fashion to prepare a mixture and stirring the mixture. This method may effectively provide a composite flame retardant in which the melamine flame retardant is uniformly coated on the surface of the phosphorus flame retardant core particles.

After completing the stirring, filtering may be carried out to remove the solvent, and a product therefrom may be dried at a temperature range of about 80° C. to about 180° C. or about 100° C. to about 140° C.

The above method may be carried out in an environmentally-friendly aqueous solvent under mild conditions and may be economical to provide a composite flame retardant realizing excellent flame retardancy due to neither damage nor deformation of the phosphorus flame retardant and the melamine flame retardant themselves.

### Elastic Sheet

Some embodiments may provide an elastic sheet for an all-solid-state rechargeable battery including a polymer resin and the composite flame retardant.

The elastic sheet may help ensure good contact between solid components by ensuring that pressure is evenly transmitted to the cell structure (or electrode assembly), and may also serve to relieve stress transmitted to the solid electrolyte, etc., and suppress cracks in the solid electrolyte due to stress accumulation as the thickness of the electrode changes during charging and discharging to play a role in buffering changes in the volume of the battery. The elastic sheet may be between the cell structures, on the outermost surface of the cell structures, or on the inner surface of the case.

The main materials used in elastic sheets may include polymer resins such as urethane, acrylic, and silicone. These materials may have the potential to act as combustibles and cause a fire if the battery temperature were to rise or a spark were to occur due to penetration or impact. Accordingly, the flame retardancy of the elastic sheet may be improved, and a flame retardant that is highly compatible with the material of the elastic sheet may be applied. The composite flame retardant according to some embodiments may have excellent compatibility with polymer resin to have good interfacial characteristics with the resin, and good dispersibility, making it suitable for application to the elastic sheet. The all-solid-state rechargeable batteries using such an elastic sheet may further improve fire safety without deteriorating electrochemical characteristics.

In the elastic sheet, the composite flame retardant may be included in an amount of about 1 to about 60 parts by weight, e.g., about 10 to about 60 parts by weight, about 20 to about 60 parts by weight, about 30 to about 60 parts by weight, or about 40 to about 50 parts by weight, based on 100 parts by weight of the polymer resin. Maintaining the content of the composite flame retardant in the elastic sheet within the above ranges may help ensure that the elastic sheet can sufficiently perform the role of buffering the volume change of the all-solid-state battery and improve flame retardancy and fire safety.

The main material of the elastic sheet may be a polymer resin, e.g., an urethane resin, an acrylic resin, a silicone resin, a fluorine resin, a copolymer thereof, or a mixture thereof.

The urethane resin may be referred to as polyurethane and refers to a homopolymer or copolymer having a urethane group. The acrylic resin may be, e.g., a polyacrylate, and refers to a homopolymer or copolymer having an acrylic group. The silicone resin refers to a homopolymer or copolymer containing silicon, and the fluorine resin refers to a homopolymer or copolymer containing fluorine. These polymers may exhibit appropriate elasticity, modulus, and compression set, making them suitable for use as elastic sheets.

The urethane resin may be derived from a polyether polyol. The polyether polyol may have 2 to 4 functional groups and a number average molecular weight of greater than or equal to about 2,000 or and less than or equal to about 4,000. In addition to polyether polyol, a polyester polyol may be used for urethane resin. The polyester polyol may be obtained by condensation of low molecular polyols, e.g., ethylene glycol, diethylene glycol, propylene glycol, butanediol, hexanediol, glycerin, trimethylolpropane, trimethylolethane, pentaerythritol, diglycerin, sorbitol, sucrose, or the like with succinic acid, sebacic acid, maleic acid, fumaric acid, phthalic acid, isophthalic acid, succinic anhydride, maleic anhydride, phthalic anhydride, or the like. In an implementation, the polyester polyol may include polyols that are ring-opening condensates of caprolactone and methylvalerolactone, which are classified as lactone esters. A polycarbonate polyol may be obtained by a dealcoholization reaction of polyhydric alcohols such as ethylene glycol, diethylene glycol, propylene glycol, butanediol, pentanediol, and hexanediol with dialkyl carbonate, dialkylene carbonate, or diphenyl carbonate. The polycarbonate polyol may have 2 to 3 functional groups and a number average molecular weight of about 500 to about 1,000 (or a hydroxyl group of about 112 mgKOH/g to about 224 mgKOH/g).

Examples of the acrylic resin may be derived from C1 to C20 alkyl acrylate, hydroxy C1 to C20 alkyl acrylate, or a combination thereof. Herein, C1 to C20 refers to the number of carbons of the alkyl group, and may be, for example, C1 to C18, C1 to C15, C1 to C12, C1 to C10, C1 to C8, or C1 to C5. Herein, the acrylate may have a concept including acrylate and methacrylate.

The C1 to C20 alkyl acrylate may be, e.g., methyl(meth)acrylate, ethyl(meth)acrylate, propyl(meth)acrylate, butyl(meth)acrylate, 2-ethylhexyl(meth)acrylate, 2-ethylpentyl(meth)acrylate, 2-ethylheptyl(meth)acrylate, 2-ethylnonyl(meth)acrylate, 2-propylhexyl(meth)acrylate, 2-propyloctyl(meth)acrylate, or a combination thereof.

The hydroxy C1 to C20 alkyl acrylate may be, e.g., 2-hydroxyethyl(meth)acrylate, 2-hydroxypropyl(meth)acrylate, 3-hydroxypropyl(meth)acrylate, 2-hydroxybutyl(meth)acrylate, 4-hydroxybutyl(meth)acrylate, or a combination thereof.

In an implementation, the acrylic resin may be derived from C1 to C20 alkyl acrylate and hydroxy C1 to C20 alkyl acrylate, in which a mixing ratio of the C1 to C20 alkyl acrylate and hydroxy C1 to C20 alkyl acrylate may be a weight ratio of about 20:80 to about 90:10, e.g., about 30:70 to about 90:10, about 40:60 to about 90:10, about 50:50 to about 90:10, or about 60:40 to about 80:20. In this case, the acrylic resin may exhibit appropriate adhesion and is advantageous for realizing excellent compressive strength, stress relaxation rate, and recovery rate.

The acrylic resin may further include other repeating units derived from acrylic acid, acrylate including an alkoxy group, etc. In an implementation, a weight average molecular weight of the acrylic resin may be about 400,000 to about 2,000,000.

The elastic sheet may further include elastic particles in addition to the polymer resin and composite flame retardant. The elastic particles may be particles made of an elastic polymer such as rubber. The elastic particles may help increase a restoring force while maintaining the stress relaxation force of the polymer resin.

The elastic particles may be included in an amount of about 0.1 to about 5 parts by weight, e.g., about 0.5 to about 4 parts by weight, or about 1 to about 3 parts by weight, based on 100 parts by weight of the polymer resin. Maintaining the amount of the elastic particles within these ranges may help ensure that compressive strength, stress relaxation force, and restoring force can be maximized without reducing the density and adhesion of the polymer resin.

The elastic particles may include, e.g., polymers derived from a natural rubber, alkyl acrylate, olefin, butadiene, isoprene, styrene, acrylonitrile, a copolymer thereof, or a combination thereof. The elastic particles may have a glass transition temperature of, e.g., about −70° C. to about 0° C.

The alkyl acrylate may be C1 to C20 alkyl acrylate, e.g., methyl(meth)acrylate, ethyl(meth)acrylate, propyl(meth)acrylate, butyl(meth)acrylate, 2-ethylhexyl(meth)acrylate, 2-ethylpentyl(meth)acrylate, 2-ethylheptyl(meth)acrylate, 2-ethylnonyl (meth)acrylate, 2-propylhexyl (meth)acrylate and 2-propyloctyl(meth)acrylate, or a combination thereof.

The elastic particles may include, e.g., an ethylene-propylene-diene rubber, a butadiene rubber, an isoprene rubber, a styrene-butadiene rubber, a styrene-isoprene rubber, an acrylonitrile-butadiene rubber, or a combination thereof.

In an implementation, the elastic particles may have a core-shell structure, in which case it may be advantageous to exhibit appropriate size and elasticity. The core and shell may each include polyalkyl acrylate, e.g., the core may include polybutyl(meth)acrylate, and the shell may include polymethyl (meth)acrylate. In this case, dispersibility is excellent and the compressive strength, stress relaxation force, and restoring force of the elastic sheet can be improved.

In an implementation, the elastic particles may be nano-sized. In an implementation, the size (D₅₀) of the elastic particles may be about 10 nm to about 900 nm, e.g., about 10 nm to about 700 nm, about 50 nm to about 500 nm, or about 100 nm to about 400 nm. Elastic particles satisfying these sizes may have excellent dispersibility within the elastic sheet and may help increase the restoring force while maintaining the stress relaxation force of the elastic sheet. Herein, the size of the elastic particle may be expressed as an average particle diameter or median particle diameter, which is measured by a particle size analyzer, and can mean the diameter (D₅₀) of a particle with a cumulative volume of 50 volume % in the particle size distribution.

The elastic sheet may further include inorganic particles, and in this case, the modulus and compressive strength of the elastic sheet may be improved while the recovery rate can be improved at the same time.

The inorganic particles may include, e.g., alumina, titania, boehmite, barium sulfate, calcium carbonate, calcium phosphate, amorphous silica, mesoporous silica, fumed silica, crystalline glass particles, kaolin, talc, silica-alumina composite oxide particles, calcium fluoride, lithium fluoride, zeolite, molybdenum sulfide, mica, magnesium oxide, or a combination thereof.

In an implementation, the inorganic particles may be included in an amount of about 0.001 to about 50 parts by weight, e.g., about 0.01 to about 45 parts by weight, or about 0.1 to about 40 parts by weight, based on 100 parts by weight of the polymer resin. In this case, the compressive strength, stress relaxation rate, and recovery rate of the elastic sheet can be improved without deteriorating the properties of the polymer resin.

An average particle diameter of the inorganic particles may be about 0.1 μm to about 5 μm, e.g. about 0.1 μm to about 2.5 μm, or about 0.2 μm to about 2 μm. The average particle size is measured using a laser scattering particle size distribution meter, and may mean the median particle size (D₅₀) when 50% of the particles are accumulated from the small particle side in volume conversion.

The elastic sheet may further include hollow particles. The hollow particles may be particles with an empty interior and can be expressed as hollow spheres or hollow beads, and may be hollow nano-particles or hollow micro-particles. In an implementation, the elastic sheet may include hollow particles, and compressive strength may be increased while maintaining an appropriate density, and a foam shape can be exhibited.

The hollow particles may be included in an amount of about 1 to about 8 parts by weight, e.g., about 1 to about 7 parts by weight, or about 2 to about 6 parts by weight, based on 100 parts by weight of the polymer resin. Including the hollow particles within these content ranges may help ensure that it is advantageous to make a foam-type elastic sheet, and the compressive strength, stress relaxation force, and restoring force of the elastic sheet can be improved.

The hollow particles may be inorganic hollow particles, organic hollow particles, or a combination thereof. In an implementation, the hollow particles may be made of inorganic materials or may be composed of organic materials such as polymers.

The inorganic hollow particles may include, e.g., glass, metal oxide, metal carbide, metal fluoride, or a combination thereof. In an implementation, the inorganic hollow particles may be made of glass, silicon oxide, nickel oxide, barium oxide, platinum oxide, zinc oxide, aluminum oxide, zirconium oxide, iron oxide, titanium oxide, calcium carbonate, magnesium fluoride, or a combination thereof. In an implementation, the inorganic hollow particle may be a glass bubble.

The organic hollow particles may include, e.g., an acrylic resin, a vinyl chloride resin, a urea resin, a phenolic resin, a rubber, or a combination thereof. In an implementation, the organic hollow particles may be expanded or non-expanded, and the expanded organic hollow particles may be expanded at, e.g., about 120° C. to about 150° C.

In an implementation, the size (D₅₀) of the hollow particle may be micro size, and may be about 1 μm to about 100 μm, about 5 μm to about 80 μm, about 10 μm to about 60 μm, or about 20 μm to about 50 μm. The hollow particles having such sizes may be advantageous for making foam-shaped elastic sheets, and may help improve the compressive strength of the elastic sheet while lowering the density and improving stress relaxation force and restoring force. Herein, the size of the hollow particle can be expressed as an average particle diameter or median particle diameter, which is measured by a particle size analyzer, and can mean the diameter (D₅₀) of a particle with a cumulative volume of 50 volume % in the particle size distribution.

In an implementation, the elastic sheet may further include suitable additives in addition to the aforementioned components, e.g., an initiator, a crosslinking agent, a coupling agent, a foam stabilizer, etc. Each additive may be included in a suitable amount according to the purpose, e.g., about 0.001 to about 1 part by weight, for example, about 0.01 to about 0.8 parts by weight, based on 100 parts by weight of the polymer resin.

A thickness of the elastic sheet may be about 100 μm to about 2,000 μm, e.g., about 100 μm to about 1,500 μm, about 100 μm to about 1,000 μm, or about 100 μm to about 800 μm. The elastic sheet according to some embodiments may be an elastic sheet whose thickness is minimized in order to implement a thin battery or maximize the capacity of the battery, and may have a thickness of, e.g., about 100 μm to about 300 μm. The composite flame retardant according to some embodiments may have high dispersibility and can achieve excellent flame retardancy even in such thin sheets. In an implementation, the composite flame retardant may be advantageous for being applied to thin elastic sheets with a thickness of about 100 μm to about 300 μm.

The elastic sheet may be in the form of a pad that is relatively soft and has a low modulus, or may be in the form of foam (foam rubber) with relatively hard physical properties.

### All-Solid-State Rechargeable Battery

Some embodiments may provide an all-solid-state rechargeable battery including a positive electrode, a negative electrode, and a solid electrolyte layer between the positive electrode and negative electrode. The all-solid-state rechargeable battery may include the aforementioned composite flame retardant, and thus fire safety can be further improved.

In an implementation, the all-solid-state rechargeable battery may include two or more cell structures including a positive electrode, a negative electrode, and a solid electrolyte layer between the positive electrode and negative electrode, elastic sheets between the cell structures and at the outermost layer. In an implementation, at least one of the elastic sheets may include the aforementioned composite flame retardant.

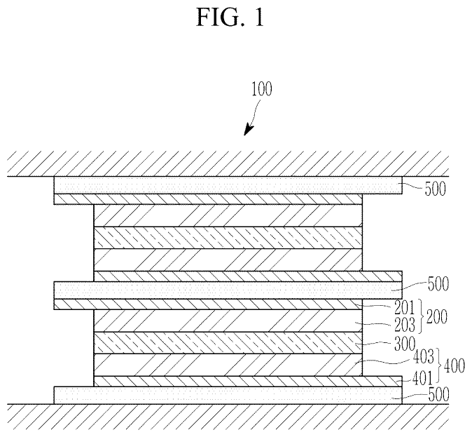

FIG. 1 is a cross-sectional view of an all-solid-state rechargeable battery according to some embodiments. Referring to FIG. 1, the all-solid-state rechargeable battery 100 may include a cell structure in which a negative electrode 400 including a negative electrode current collector 401 and a negative electrode active material layer 403, a solid electrolyte layer 300, and a positive electrode 200 including a positive electrode current collector 201 and a positive electrode active material layer 203 are stacked is housed in a battery case. In an implementation, as illustrated in FIG. 1, an assembly may include two cell structures including the negative electrode 400, the solid electrolyte layer 300, and the positive electrode 200 stacked, or three or more, e.g., 2 to 200, 3 to 100, 4 to 50, etc. may be stacked.

The all-solid-state rechargeable battery 100 may further include an elastic sheet 500 outside at least one of the positive electrode 200 and the negative electrode 400. In an implementation, the elastic sheet 500 may be between the cell structures or may be on the outermost portion of the cell structures. At least one of the elastic sheets 500 in the battery according to some embodiments may be an elastic sheet including the aforementioned composite flame retardant. In an implementation, the flame retardancy and fire safety of rechargeable lithium batteries can be further improved.

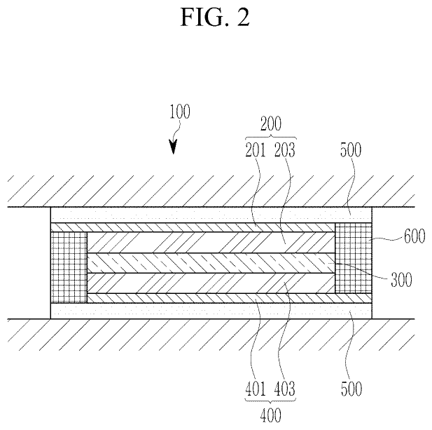

In an implementation, an all-solid-state rechargeable battery 100 may include a cell structure including a positive electrode 200, a negative electrode 400, and a solid electrolyte layer 300 between the positive electrode 200 and negative electrode 400, and a resin layer 600 on a side of the cell structure. In an implementation, the resin layer 600 may include a resin and the aforementioned composite flame retardant. FIG. 2 is a cross-section of an all-solid-state rechargeable battery showing a resin layer. The resin layer 600 may be on the side of the cell structure and may help maintain the shape of the cell structure and improve insulation, adhesion, heat dissipation, etc.

The resin, which may be the main material of the resin layer, may include, e.g., polyvinylidene fluoride, polyvinylpyrrolidone, polytetrafluoroethylene, polyvinyl alcohol, carboxymethyl cellulose, hydroxypropyl cellulose, diacetyl cellulose, polyvinylchloride, carboxylated polyvinylchloride, polyethylene, polypropylene, a styrene-butadiene rubber, an acrylated styrene-butadiene rubber, an epoxy resin, polyurethane, nylon, polyamideimide, polyimide, poly(meth)acrylate, polyacrylonitrile, polystyrene, acrylic resin, or a combination thereof. In an implementation, the resin may be composed of an acrylate polymer having an ethylene oxide group, a urethane acrylate polymer, an epoxy acrylate polymer, a mercapto acrylate polymer, or a combination thereof.

In the resin layer, the composite flame retardant may be included in an amount of about 1 to about 60 parts by weight, e.g., about 10 to about 60 parts by weight, about 20 to about 60 parts by weight, about 30 to about 60 parts by weight, or about 40 to about 50 parts by weight based on 100 parts by weight of the resin. Maintaining the content of the composite flame retardant in the resin layer within the above ranges may help ensure that the flame retardancy and fire safety of the resin layer can be improved without changing the physical properties.

### Positive Electrode

In an implementation, the positive electrode may include a current collector and a positive electrode active material layer on the current collector, and the positive electrode active material layer may include a positive electrode active material and may optionally include a solid electrolyte, a binder, or a conductive material.

### Positive Electrode Active Material

The positive electrode active material may include a compound (lithiated intercalation compound) being capable of intercalating and deintercalating lithium. In an implementation, a composite oxide of lithium and a metal, e.g., cobalt, manganese, nickel, or combinations thereof, may be used.

The composite oxide may be a lithium transition metal composite oxide, and examples thereof may include lithium nickel oxide, lithium cobalt oxide, lithium manganese oxide, lithium iron phosphate compound, cobalt-free lithium nickel-manganese oxide, overlithiated layered oxide, or a combination thereof.

In an implementation, the positive electrode active material may be a high nickel positive electrode active material having a nickel content of greater than or equal to about 80 mol %, based on 100 mol % of metals excluding lithium in the lithium transition metal composite oxide. The nickel content in the high nickel positive electrode active material may be greater than or equal to about 85 mol %, greater than or equal to about 90 mol %, greater than or equal to about 91 mol %, or greater than or equal to about 94 mol % and less than or equal to about 99 mol % based on 100 mol % of metals excluding lithium. The high-nickel positive electrode active materials can achieve high capacity and can be applied to high-capacity, high-density rechargeable lithium batteries.

In an implementation, a compound represented by any of the following chemical formulas may be used. LiₐA_{1-b}X_{b}O_{2-c}D′_{c} (0.90≤a≤1.8, 0≤b≤0.5, 0≤c≤0.05); LiₐMn_{2-b}X_{b}O_{4-c}D′_{c} (0.90≤a≤1.8, 0≤b≤0.5, 0≤c≤0.05); LiₐNi_{1-b-c}Co_{b}X_{c}O_{2-α}D′_{α} (0.90≤a≤1.8, 0≤b≤0.5, 0≤c≤0.5, 0<α<2); LiₐNi_{1-b-c}Mn_{b}X_{c}O_{2-α}D′_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃(0≤f≤2); and LiₐFePO₄ (0.90≤a≤1.8)

In the above chemical formulas, A may be Ni, Co, Mn, or a combination thereof, X may be Al, Ni, Co, Mn, Cr, Fe, Mg, Sr, V, a rare earth element, or a combination thereof, D′ may be 0, F, S, P, or a combination thereof, G may be Al, Cr, Mn, Fe, Mg, La, Ce, Sr, V, or a combination thereof, and L¹ may be Mn, Al, or a combination thereof.

The positive electrode active material may include, e.g., lithium nickel oxide represented by Chemical Formula 11, lithium cobalt oxide represented by Chemical Formula 12, lithium iron phosphate compound represented by Chemical Formula 13, cobalt-free lithium nickel-manganese oxide represented by Chemical Formula 14, or a combination thereof.

Liₐ₁Niₓ₁M¹_{y1}M²_{z1}O_{2-b1}X_{b1} [Chemical Formula 11]

In Chemical Formula 11, 0.9≤a1≤1.8, 0.3≤x1≤1, 0≤y1≤0.7, 0≤z1≤0.7, 0.9≤x1+y1+z1≤1.1, and 0≤b1≤0.1, M¹ and M² may each independently be Al, B, Ba, Ca, Ce, Co, Cr, Cu, Fe, Mg, Mn, Mo, Nb, Si, Sn, Sr, Ti, V, W, or Zr, and X may be F, P, or S.

In Chemical Formula 1, 0.6≤x1≤1, 0≤y1≤0.4, and 0≤z1≤0.4, or 0.8≤x1≤1, 0≤y1≤0.2, and 0≤z1≤0.2.

Liₐ₂Coₓ₂M³_{y2}O_{2-b2}X_{b2} [Chemical Formula 12]

In Chemical Formula 12, 0.9≤a2≤1.8, 0.7≤x2≤1, 0≤y2≤0.3, 0.9≤x2+y2≤1.1, and 0≤b2≤0.1, M³ may be Al, B, Ba, Ca, Ce, Cr, Cu, Fe, Mg, Mn, Mo, Ni, Se, Si, Sn, Sr, Ti, V, W, Y, Zn, or Zr, and X may be F, P, or S.

Liₐ₃Feₓ₃M⁴_{y3}PO_{4-b3}X_{b3} [Chemical Formula 13]

In Chemical Formula 13, 0.9≤a3≤1.8, 0.6≤x3≤1, 0≤y3≤0.4, and 0≤b3≤0.1, M⁴ may be Al, B, Ba, Ca, Ce, Co, Cr, Cu, Mg, Mn, Mo, Ni, Se, Si, Sn, Sr, Ti, V, W, Y, Zn, or Zr, and X may be F, P, or S.

Liₐ₄Niₓ₄Mn_{y4}M⁵_{z4}O_{2-b4}X_{b4} [Chemical Formula 14]

In Chemical Formula 14, 0.9≤a2≤1.8, 0.8≤x4<1, 0<y4≤0.2, 0≤z4≤0.2, 0.9≤x4+y4+z4≤1.1, and 0≤b4≤0.1, M⁵ may be Al, B, Ba, Ca, Ce, Cr, Fe, Mg, Mo, Nb, Si, Sn, Sr, Ti, V, W, or Zr, and X may be F, P, or S.

The average particle diameter (D₅₀) of the positive electrode active material may be about 1 μm to about 25 μm, e.g., about 3 μm to about 25 μm, about 1 μm to about 20 μm, about 1 μm to about 18 μm, about 3 μm to about 15 μm, or about 5 μm to about 15 μm. In an implementation, the positive electrode active material may include small particles having an average particle diameter (D₅₀) of about 1 μm to about 9 μm and large particles having an average particle diameter (D₅₀) of about 10 μm to about 25 μm. The positive electrode active material having this particle size range can be harmoniously mixed with other components within the positive electrode active material layer and can achieve high capacity and high energy density. Herein, the average particle diameter may be obtained by selecting about 20 particles at random in the scanning electron microscopic image of the positive electrode active material, measuring the particle diameter (diameter, long axis, or length of the long axis) to obtain the particle size distribution, and taking the diameter (D₅₀) of particles with a cumulative volume of 50 volume % as the average particle diameter in the particle size distribution.

The positive electrode active material may be in the form of secondary particles made by agglomerating a plurality of primary particles, or may be in the form of single particles. In an implementation, the positive electrode active material may have a spherical or close to spherical shape, or may have a polyhedral or irregular shape.

In an implementation, the positive electrode active material may include a buffer layer on the particle surface. The buffer layer can be expressed as a coating layer, a protective layer, etc., and can play a role in lowering the interfacial resistance between the positive electrode active material and the sulfide solid electrolyte particles. In an implementation, the buffer layer may include lithium-metal-oxide, wherein the metal may be, e.g., Al, B, Ca, Ce, Cr, Fe, Mg, Mo, Nb, Si, Sn, Sr, Ta, V, W, or Zr. The lithium-metal-oxide may be excellent for improving the performance of the positive electrode active material by facilitating the movement of lithium ions and electronic conduction, while lowering the interfacial resistance between the positive electrode active material and solid electrolyte particles.

The positive electrode active material may be included in an amount of about 55 wt % to about 99.5 wt %, e.g., about 65 wt % to about 95 wt %, or about 75 wt % to about 91 wt %, based on a total weight of the positive electrode active material layer.

### Binder

The binder may help improve binding properties of positive electrode active material particles with one another and with a current collector. Examples of the binder may include polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon.

### Conductive Material

The conductive material may be included to provide electrode conductivity and any electrically conductive material may be used as a conductive material unless it causes a chemical change. Examples of the conductive material may include a carbon material such as natural graphite, artificial graphite, carbon black, acetylene black, ketjen black, a carbon fiber, a carbon nanofiber, a carbon nanotube, and the like; a metal material of a metal powder or a metal fiber including copper, nickel, aluminum, silver, and the like; a conductive polymer such as a polyphenylene derivative; or a mixture thereof.

Each content of the binder and the conductive material may be about 0.5 wt % to about 5 wt %, based on a total weight of the positive electrode active material layer.

In an implementation, the positive electrode active material layer may further include a solid electrolyte. The solid electrolyte may include, e.g., a sulfide solid electrolyte, an oxide solid electrolyte, a halide solid electrolyte, or a combination thereof.

Based on a total weight of the positive electrode active material layer, the solid electrolyte may be included in an amount of about 0.1 wt % to about 35 wt %, e.g., about 1 wt % to about 35 wt %, about 5 wt % to about 30 wt %, about 8 wt % to about 25 wt %, or about 10 wt % to about 20 wt %.

In the positive electrode active material layer, based on a total weight of the positive electrode active material and the solid electrolyte, about 65 wt % to about 99 wt % of the positive electrode active material and about 1 wt % to about 35 wt % of the solid electrolyte may be included, for example, about 80 wt % to about 90 wt % of the positive electrode active material and about 10 wt % to about 20 wt % of the solid electrolyte. Within these amount ranges, the efficiency and cycle-life characteristics of the all-solid-state rechargeable battery can be improved without reducing the capacity.

The current collector may include Al.

### Negative Electrode

A negative electrode for an all-solid-state rechargeable battery may include a current collector and a negative electrode active material layer on the current collector. The negative electrode active material layer may include a negative electrode active material and may further include a binder or a conductive material.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, e.g., crystalline carbon, amorphous carbon, or a combination thereof, as a carbon negative electrode active material. The crystalline carbon may be irregular, or sheet, flake, spherical, or fiber shaped natural graphite or artificial graphite. The amorphous carbon may be a soft carbon, a hard carbon, a mesophase pitch carbonization product, calcined coke, or the like.

The lithium metal alloy may include an alloy of lithium and a metal, e.g., Na, K, Rb, Cs, Fr, Be, Mg, Ca, Sr, Si, Sb, Pb, In, Zn, Ba, Ra, Ge, Al, or Sn.

The material capable of doping/dedoping lithium may be a Si negative electrode active material or a Sn negative electrode active material. The Si negative electrode active material may include silicon, a silicon-carbon composite, SiOₓ (0<x<2), a Si-Q alloy (wherein Q is an element selected from an alkali metal, an alkaline-earth metal, a Group 13 element, a Group 14 element (excluding Si), a Group 15 element, a Group 16 element, a transition metal, a rare earth element, and a combination thereof), or a combination thereof. The Sn negative electrode active material may be Sn, SnO₂, a Sn alloy, or a combination thereof.

The silicon-carbon composite may be a composite of silicon and amorphous carbon. In an implementation, the silicon-carbon composite may be in the form of silicon particles and amorphous carbon coated on the surface of the silicon particles. In an implementation, it may include a secondary particle (core) in which silicon primary particles are assembled and an amorphous carbon coating layer (shell) on the surface of the secondary particle. The amorphous carbon may also be present between the silicon primary particles, e.g., the silicon primary particles may be coated with amorphous carbon. The secondary particles may exist dispersed in an amorphous carbon matrix.

The silicon-carbon composite may further include crystalline carbon. In an implementation, the silicon-carbon composite may include a core including crystalline carbon and silicon particles and an amorphous carbon coating layer on the surface of the core.

The Si negative electrode active material or Sn negative electrode active material may be mixed with the carbon negative electrode active material.

In the negative electrode active material layer, the negative electrode active material may be included in an amount of about 95 wt % to about 99 wt %, based on a total weight of the negative electrode active material layer. In an implementation, the negative electrode active material layer may include about 90 wt % to about 99 wt % of the negative electrode active material, about 0.5 wt % to about 5 wt % of the binder, and about 0 wt % to about 5 wt % of the conductive material.

The binder may serve to well adhere the negative electrode active material particles to each other and also to adhere the negative electrode active material to the current collector. The binder may be a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include a styrene-butadiene rubber, a (meth)acrylated styrene-butadiene rubber, a (meth)acrylonitrile-butadiene rubber, a (meth)acrylic rubber, butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

In an implementation, an aqueous binder may be used as the negative electrode binder, and a cellulose compound capable of imparting viscosity may be further included. The cellulose compound may include carboxymethyl cellulose, hydroxypropylmethyl cellulose, methyl cellulose, or alkali metal salts thereof, which may be mixed and used. The alkali metal may be Na, K, or Li.

The dry binder may be a polymer material capable of becoming fiber, and may be, e.g., polytetrafluoroethylene, polyvinylidene fluoride, a polyvinylidene fluoride-hexafluoropropylene copolymer, polyethylene oxide, or a combination thereof.

The conductive material may be included to provide electrode conductivity and a suitable electrically conductive material that does not cause a chemical change may be used. Examples of the conductive material may include a carbon material such as natural graphite, artificial graphite, carbon black, acetylene black, ketjen black, a carbon fiber, a carbon nanofiber, a carbon nanotube, or the like; a metal material of a metal powder or a metal fiber including copper, nickel, aluminum silver, or the like; a conductive polymer such as a polyphenylene derivative; or a mixture thereof.

The negative electrode current collector may include, e.g., a copper foil, a nickel foil, a stainless steel foil, a titanium foil, a nickel foam, a copper foam, a polymer substrate coated with a conductive metal, or a combination thereof.

In an implementation, the negative electrode for an all-solid-state rechargeable battery may be a precipitation-type negative electrode. The precipitation-type negative electrode may not include a negative electrode active material during battery assembly, but may refer to a negative electrode in which lithium metal, etc. is precipitated or electrodeposited on the negative electrode during battery charging, thereby serving as a negative electrode active material.

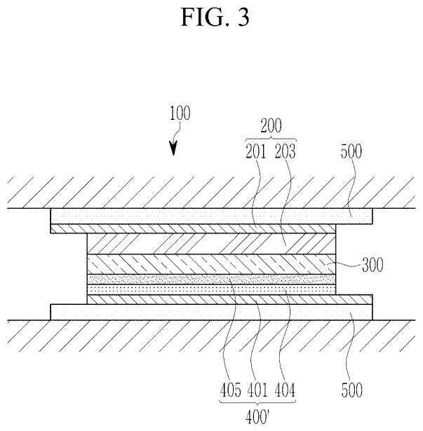

FIG. 3 is a schematic cross-sectional view of an all-solid-state rechargeable battery including a precipitation-type negative electrode. Referring to FIG. 3, the precipitation-type negative electrode 400′ may include a current collector 401 and a negative electrode coating layer 405 on the current collector. In an all-solid-state rechargeable battery having such a precipitation-type negative electrode 400′, initial charging begins in the absence of negative electrode active material, and during charging, high-density lithium metal is precipitated or electrodeposited between the current collector 401 and the negative electrode coating layer 405 or on the negative electrode coating layer 405 to form a lithium metal layer 404, which can serve as a negative electrode active material. Accordingly, in an all-solid-state rechargeable battery that has been charged at least once, the precipitation-type negative electrode 400′ may include, for example, a current collector 401, a lithium metal layer 404 on the current collector 401, and a negative electrode coating layer 405 on the metal layer 404. The lithium metal layer 404 may be referred to as a layer in which lithium metal, etc. is precipitated during the charging process of the battery, and may be referred to as a metal layer, lithium layer, lithium electrodeposition layer, or negative electrode active material layer.

The negative electrode coating layer 405 may also be referred to as a lithium electrodeposition inducing layer or a negative electrode catalyst layer, and may include a metal, a carbon material, or a combination thereof that acts as a catalyst.

The metal may be a lithiophilic metal and may include, e.g., gold, platinum, palladium, silicon, silver, aluminum, bismuth, tin, zinc, or a combination thereof, or may be composed of one of these or various types of alloys. When the lithiophilic metal exists in particle form, and its average particle diameter (D₅₀) may be less than or equal to about 4 μm, e.g., about 10 nm to about 4 μm.

The carbon material may be, e.g., crystalline carbon, amorphous carbon, or a combination thereof. The crystalline carbon may be, e.g., natural graphite, artificial graphite, mesophase carbon microbeads, or a combination thereof. The amorphous carbon may be, e.g., carbon black, activated carbon, acetylene black, denka black, ketjen black, or a combination thereof.

When the negative electrode coating layer 405 includes both the metal and the carbon material, the mixing ratio of the metal and the carbon material may be, e.g., a weight ratio of about 1:10 to about 2:1. In this case, precipitation of lithium metal can be effectively promoted and the characteristics of the all-solid-state rechargeable battery can be improved. In an implementation, the negative electrode coating layer 405 may include a carbon material on which a catalyst metal is supported, or may include a mixture of metal particles and carbon material particles.

In an implementation, the negative electrode coating layer 405 may include the lithiophilic metal and amorphous carbon, and in this case, it can effectively promote precipitation of lithium metal. In an implementation, the negative electrode coating layer 405 may include a composite in which a lithiophilic metal is supported on amorphous carbon.

The negative electrode coating layer 405 may further include a binder, and the binder may be, e.g., a conductive binder. In an implementation, the negative electrode coating layer 405 may further include an additive, e.g., such as a filler, a dispersant, an ion conductive agent, or the like.

A thickness of the negative electrode coating layer 405 may be, e.g., about 100 nm to about 20 μm, or about 500 nm to about 10 μm, or about 1 μm to about 5 μm.

The precipitation-type negative electrode 400′ may further include a thin film, e.g., on the surface of the current collector, e.g., between the current collector and the negative electrode catalyst layer. The thin film may include an element capable of forming an alloy with lithium. The element capable of forming an alloy with lithium may be, e.g., gold, silver, zinc, tin, indium, silicon, aluminum, bismuth, or the like, which may be used alone or an alloy of more than one. The thin film may help further planarize a precipitation shape of the lithium metal layer 404 and much improve characteristics of the all-solid-state rechargeable battery. The thin film may be formed, e.g., in a vacuum deposition method, a sputtering method, a plating method, and the like. The thin film may have, e.g., a thickness of about 1 nm to about 500 nm.

The lithium metal layer 404 may include a lithium metal or a lithium alloy. The lithium alloy may be, e.g., a Li—Al alloy, a Li—Sn alloy, a Li—In alloy, a Li—Ag alloy, a Li—Au alloy, a Li—Zn alloy, a Li—Ge alloy, or a Li—Si alloy.

A thickness of the lithium metal layer 404 may be about 1 μm to about 500 μm, e.g., about 1 μm to about 200 μm, about 1 μm to about 100 μm, or about 1 μm to about 50 μm. If the thickness of the lithium metal layer 404 were to be too thin, it could be difficult to perform the role of a lithium storage. If it were to be too thick, the battery volume could increase and performance could deteriorate.

When applying such a precipitation-type negative electrode, the negative electrode coating layer 405 may serve to protect the lithium metal layer 404 and suppress the precipitation growth of lithium dendrite. In an implementation, short circuit and capacity degradation of the all-solid-state battery may be suppressed and cycle-life characteristics can be improved.

### Solid Electrolyte Layer

The solid electrolyte layer may include a solid electrolyte. The solid electrolyte may be a type of inorganic solid electrolyte, and may include, e.g., a sulfide solid electrolyte, an oxide solid electrolyte, a halide solid electrolyte, or a combination thereof. The solid electrolyte layer according to some embodiments may include a sulfide solid electrolyte.

### Sulfide Solid Electrolyte

The sulfide solid electrolyte may include, e.g. Li₂S—P₂S₅, Li₂S—P₂S₅—LiX (wherein X is a halogen element, for example I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are an integer, respectively, and Z is Ge, Zn, or Ga), Li₂S—GeS₂, Li₂S—SiS₂—Li₃PO₄, Li₂S—SiS₂-LiₚMO_{q} (wherein p and q are integers, and M is P, Si, Ge, B, Al, Ga, or In), or a combination thereof.

Such a sulfide solid electrolyte may be obtained by, e.g., mixing Li₂S and P₂S₅ in a molar ratio of about 50:50 to about 90:10 or about 50:50 to about 80:20 and optionally performing heat-treatment. Within the above mixing ratio ranges, a sulfide solid electrolyte having excellent ionic conductivity may be prepared. The ionic conductivity may be further improved by adding SiS₂, GeS₂, B₂S₃, or the like as other components thereto.

Mechanical milling or a solution method may be applied as a mixing method of sulfur-containing raw materials for preparing a sulfide solid electrolyte. The mechanical milling may make starting materials into particulates by putting the starting materials in a ball mill reactor and vigorously stirring them. The solution method may be performed by mixing the starting materials in a solvent to obtain a solid electrolyte as a precipitate. In an implementation, in the case of heat-treatment after mixing, crystals of the solid electrolyte may be more robust and ionic conductivity may be improved. In an implementation, the sulfide solid electrolyte may be prepared by mixing sulfur-containing raw materials and performing heat treatment two or more times. In this case, a sulfide solid electrolyte having high ionic conductivity and robustness may be prepared.

The sulfide solid electrolyte particles according to some embodiments, e.g., may be prepared through a first heat treatment of mixing sulfur-containing raw materials and firing at about 120° C. to about 350° C. and a second heat treatment of mixing the resultant of the first heat treatment and firing the same at about 350° C. to about 800° C. The first heat treatment and the second heat treatment may be performed under an inert gas or nitrogen atmosphere, respectively. The first heat treatment may be performed for about 1 hour to about 10 hours, and the second heat treatment may be performed for about 5 hours to about 20 hours. Small raw materials may be milled through the first heat treatment, and a final solid electrolyte can be synthesized through the second heat treatment. Through such two or more heat treatments, a sulfide solid electrolyte having high ionic conductivity and high performance can be obtained, and such a solid electrolyte may be suitable for mass production. The temperature of the first heat treatment may be, e.g., about 150° C. to about 330° C., or about 200° C. to about 300° C., and the temperature of the second heat treatment may be, e.g., about 380° C. to about 700° C., or about 400° C. to about 600° C.

In an implementation, the sulfide solid electrolyte particles may include argyrodite-type sulfide. The argyrodite-type sulfide solid electrolyte particle may have high ionic conductivity close to the range of about 10-4 to about 10-2 S/cm, which is the ionic conductivity of some other liquid electrolytes at room temperature, and may form an intimate bond between the positive electrode active material and the solid electrolyte without causing a decrease in ionic conductivity, and furthermore, an intimate interface between the electrode layer and the solid electrolyte layer. An all-solid-state rechargeable battery including the same may have improved battery performance such as rate capability, coulombic efficiency, and cycle-life characteristics.

In an implementation, the argyrodite-type sulfide solid electrolyte particles may include a compound represented by Chemical Formula 21.

(LiₐM¹_{b}M²_{c})(P_{d}M³ₑ)(S_{f}M⁴_{g})Xₕ [Chemical Formula 21]

In Chemical Formula 21, 4≤a≤8, M¹ may be Mg, Cu, Ag, or a combination thereof, 0≤b<0.5, M² may be Na, K, or a combination thereof, 0≤c≤0.5, M³ may be Sn, Zn, Si, Sb, Ge, or a combination thereof, 0<d<4, 0≤e<1, M⁴ may be O, SOₙ, N, or a combination thereof, 1.5≤n≤5, 3≤f≤12, 0≤g<2, X may be F, Cl, Br, I, or a combination thereof, and 0≤h≤2.

In an implementation, in Chemical Formula 21, a halide element (X) may be necessarily included, and in this case, it may be expressed as 0<h≤2. In an implementation, the M¹ element may be necessarily included in Chemical Formula 21, and in this case, it may be expressed as 0<b<0.5. In Chemical Formula 21, M³ may be understood as an element substituted for P and may be 0<e<1. In Chemical Formula 21, M⁴ is substituted for S and, e.g., may be 0<g<2, and f, a ratio of S, may be, e.g., 3≤f≤7.

In an implementation, M⁴ may be SOₙ, and SOₙ may be, e.g., S₄O₆, S₃O₆, S₂O₃, S₂O₄, S₂O₅, S₂O₆, S₂O₇, S₂O₈, SO₄, or SO₅. In an implementation, it may be SO₄.

In an implementation, in Chemical Formula 21, a+b+c+h=7, d+e=1, and f+g+h=6.

In an implementation, the argyrodite-type sulfide solid electrolyte particles may include Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, Li_{5.75}PS_{4.75}Cl_{1.25}, (Li_{5.69}Cu_{0.06}) PS_{4.75}Cl_{1.25}, (Li_{5.72}Cu_{0.03}) PS_{4.75}Cl_{1.25}, (Li_{5.69}Cu_{0.06})P(S_{4.70}(SO₄)_{0.05}) Cl_{1.25}, (Li_{5.69}Cu_{0.06})P(S_{4.60}(SO₄)_{0.15}) Cl_{1.25}, (Li_{5.72}Cu_{0.03})P(S_{4.725}(SO₄)_{0.025}) Cl_{1.25}, (Li_{5.72}Na_{0.03})P(S_{4.725}(SO₄)_{0.025}) Cl_{1.25}, Li_{5.75}P(S_{4.725}(SO₄)_{0.025}) Cl_{1.25}, or a combination thereof.

The argyrodite-type sulfide solid electrolyte may be prepared, e.g., by mixing lithium sulfide and phosphorus sulfide, and optionally lithium halide. Heat treatment may be performed after mixing them. The heat treatment may be carried out at a temperature range of about 400° C. to about 600° C., e.g. about 450° C. to about 500° C., or about 460° C. to about 490° C., for about 5 hours to about 30 hours, about 10 hours to about 24 hours, or about 15 hours to about 20 hours. Under the above conditions, ionic conductivity may be maximized. The heat treatment may include, e.g., two or more heat treatment steps. The method of preparing the argyrodite-type sulfide solid electrolyte may include, e.g., a first heat treatment in which raw materials are mixed and fired at about 120° C. to about 350° C., and a second heat treatment in which the resultant of the first heat treatment is mixed again and fired at about 350° C. to about 800° C.

An average particle diameter (D₅₀) of the sulfide solid electrolyte particles may be, e.g., about 0.1 μm to about 5.0 μm or about 0.1 μm to about 3.0 μm, and may be small particles of about 0.1 μm to about 1.9 μm or large particles of about 2.0 μm to about 5.0 μm. The sulfide solid electrolyte particles may be a mixture of small particles having an average particle diameter of about 0.1 μm to about 1.9 μm and large particles having an average particle diameter of about 2.0 μm to about 5.0 μm. The average particle diameter of the sulfide solid electrolyte particles may be measured using an electron microscope image, e.g., a particle size distribution may be obtained by measuring the size (diameter or length of the long axis) of about 20 particles in a scanning electron microscopic image, and D₅₀ may be calculated therefrom.

### Oxide Solid Electrolyte

The oxide solid electrolyte may include, e.g., Li₁₊ₓTi₂₋ₓAl(PO₄)₃(LTAP) (0≤x≤4), Li_{1+x+y}AlₓTi₂₋ₓSi_{y}P_{3-y}O₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+X+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, Garnet ceramics Li₃₊ₓLa₃M₂O₁₂ (wherein M=Te, Nb, or Zr; x is an integer of 1 to 10), or a mixture thereof.

### Halide Solid Electrolyte

The solid electrolyte layer may further include, e.g., a halide solid electrolyte. The halide solid electrolyte may include a halogen element as a main component, meaning that a ratio of the halide element to all elements constituting the solid electrolyte is about 50 mol % or more, about 70 mol % or more, about 90 mol % or more, or about 100 mol %. In an implementation, the halide solid electrolyte may not include sulfur element.

The halide solid electrolyte may include a lithium element, a metal element other than lithium, and a halogen element. The metal element other than lithium may include Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof. The halogen element may be F, Cl, Br, I, or a combination thereof, e.g., it may be Cl, Br, or a combination thereof. The halide solid electrolyte may be, e.g., represented by LiₐM₁X₆ (M is Al, As, B, Bi, Ca, Cd, Co, Cr, Fe, Ga, Hf, In, Mg, Mn, Ni, Sb, Sc, Sₙ, Ta, Ti, Y, Zn, Zr, or a combination thereof, X is F, Cl, Br, I, or a combination thereof, and 2≤a≤3). The halide solid electrolyte may include, e.g., Li₂ZrCl₆, Li_{2.7}Y_{0.7}Zr_{0.3}Cl₆, Li_{2.5}Y_{0.5}Zr_{0.5}Cl₆, Li_{2.5}In_{0.5}Zr_{0.5}Cl₆, Li₂In_{0.5}Zr_{0.5}Cl₆, Li₃YBr₆, Li₃YCl₆, Li₃YBr₂Cl₄, Li₃YbCl₆, Li_{2.6}Hf_{0.4}Yb_{0.6}Cl₆, or a combination thereof.

### Binder

The solid electrolyte layer may further include a binder. The binder may include, e.g. a nitrile-butadiene rubber, a hydrogenated nitrile-butadiene rubber, a styrene-butadiene rubber, an acrylated styrene-butadiene rubber, an acrylonitrile-butadiene rubber, an acrylic rubber, a butyl rubber, a fluorine rubber, a natural rubber, polydimethylsiloxane, polyethyleneoxide, polyvinylpyrrolidone, polyvinylpyridine, chlorosulfonatedpolyethylene, polyvinyl alcohol, polytetrafluoroethylene, polyvinylidene fluoride, a polyvinylidene fluoride-hexafluoropropylene copolymer, polyvinylchloride, carboxylated polyvinylchloride, polyvinylfluoride, polyethylene, polypropylene, an ethylene-propylene copolymer, an ethylene-propylene-diene copolymer, polyamideimide, polyimide, poly(meth)acrylate, polyacrylonitrile, polystyrene, polyurethane, a copolymer thereof, or a combination thereof.

The binder may be included in an amount of about 0.1 wt % to about 3 wt %, e.g., about 0.5 wt % to about 2 wt %, or about 0.5 wt % to about 1.5 wt %, based on a total weight of the solid electrolyte layer. Within the above ranges, the components in the solid electrolyte layer can be well combined without reducing the ionic conductivity of the solid electrolyte, thereby improving durability and reliability of the battery.

### Other Components

In an implementation, the solid electrolyte layer may optionally further include an alkali metal salt, an ionic liquid, or a conductive polymer.

The alkali metal salt may be, e.g., a lithium salt. A concentration of the lithium salt in the solid electrolyte layer may be greater than or equal to about 1 M, e.g., about 1 M to about 4 M. In an implementation, the lithium salt may help improve ionic conductivity by improving lithium ion mobility of the solid electrolyte layer.

The lithium salt may include, e.g., LiPF₆, LiBF₄, LiSbF₆, LiAsF₆, LiClO₄, LiAlO₂, LiAlCl₄, LiPO₂F₂, LiCl, LiI, LiSCN, LiN(CN)₂, lithium bis(oxalato) borate (LiBOB), lithium difluoro (oxalato) borate (LiDFOB), lithium difluorobis(oxalato)phosphate (LiDFBP), lithium bis(trifluoromethanesulfonyl)imide (LiTFSI), lithium bis(fluoro) sulfonyl)imide (LiFSI), lithium bis(pentafluoroethanesulfonyl)imide (LiBETI), lithium trifluoromethane sulfonate, lithium tetrafluoroethane sulfonate, or a combination thereof.

In an implementation, the lithium salt may be an imide lithium salt, e.g., LiTFSI, LiFSI, LiBETI, or a combination thereof. The imide lithium salt may help maintain or improve ionic conductivity by appropriately maintaining chemical reactivity with the ionic liquid.

The ionic liquid has a melting point below room temperature, so it is in a liquid state at room temperature and refers to a salt or room temperature molten salt composed of ions alone.

The ionic liquid may be a compound including a cation, e.g., ammonium, pyrrolidinium, pyridinium, pyrimidinium, imidazolium, piperidinium, pyrazolium, oxazolium, pyridazinium, phosphonium, sulfonium, triazolium, or a mixture thereof, and an anion, e.g., BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, or (CF₃SO₂)₂N⁻.

The ionic liquid may include, e.g., N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide, or 1-ethyl-3-methylimidazolium bis(trifluoromethylsulfonyl)amide.

A weight ratio of the solid electrolyte and the ionic liquid in the solid electrolyte layer may be about 0.1:99.9 to about 90:10, e.g., about 10:90 to about 90:10, about 20:80 to about 90:10, about 30:70 to about 90:10, about 40:60 to about 90:10, or about 50:50 to about 90:10. The solid electrolyte layer satisfying the above ranges may help maintain or improve ionic conductivity by improving the electrochemical contact area with the electrode. Accordingly, the energy density, discharge capacity, rate capability, etc. of the all-solid-state rechargeable battery may be improved.

An all-solid-state rechargeable battery may be a unit cell with a structure positive electrode/solid electrolyte layer/negative electrode, a bicell with a structure of positive electrode/solid electrolyte layer/negative electrode/solid electrolyte layer/positive electrode, or a stacked battery in which the structure of the unit cell is repeated.

The shape of the all-solid-state rechargeable battery may be, e.g., coin-shaped, button-shaped, sheet-shaped, stacked-shaped, cylindrical, flat, etc. In an implementation, the all-solid-state rechargeable battery may also be applied to large batteries used in electric vehicles, etc. In an implementation, the all-solid-state rechargeable battery may also be used in hybrid vehicles such as plug-in hybrid electric vehicles (PHEV). In an implementation, it may be used in a field requiring a large amount of power storage, and may be used, e.g., in an electric bicycle or a power tool. In an implementation, the all-solid-state rechargeable battery may be used in various fields such as portable electronic devices.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

### 1. Preparation of Composite Flame Retardant

6 g of melamine cyanurate (MC) was dissolved in 300 mL of distilled water for 1 hour at 80° C. Separately, 24 g of aluminum diethyl phosphinate (ADP) was dispersed in 300 mL of distilled water. Herein, MC and ADP were used in a weight ratio of 8:2. 300 mL of the solution prepared by dispersing ADP was slowly added to the MC aqueous solution and then, stirred for 2 hours. After completing a reaction, the solution was filtered by placing a filter paper in a funnel and dried at 120° C. to obtain composite flame retardant powder in which the ADP particles were encapsulated with MC coated on the surface thereof.

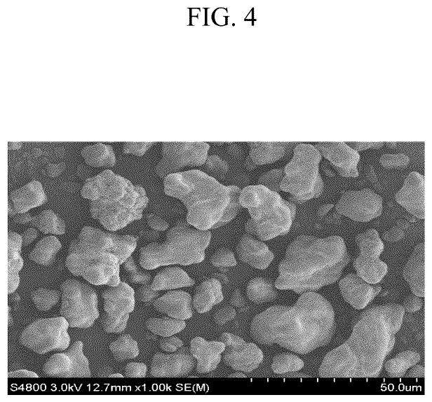

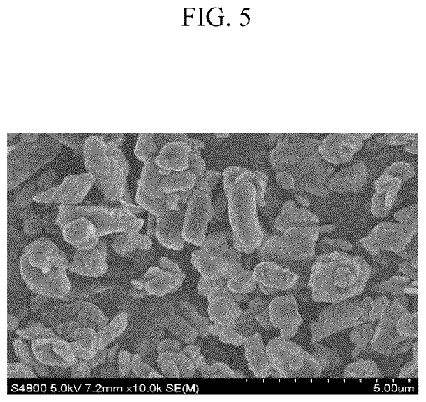

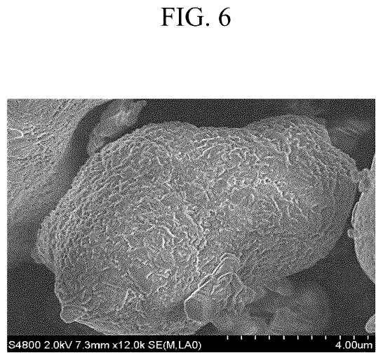

FIG. 4 is an SEM image of the ADP particles corresponding to core particles, and FIG. 5 is an SEM image of the MC particles used as a coating layer material. FIG. 6 is an SEM image of the composite flame retardant prepared by the method. Referring to FIG. 6, MC, which was dissolved in distilled water, was precipitated to wrap the ADP particles, when ADP was added thereto, and coated on the surface of ADP.

### 2. Manufacture of Elastic Sheet

An acrylic resin was prepared by using 25 parts by weight of 2-ethylhexyl acrylate, 25 parts by weight of isobornyl acrylate, and 50 parts by weight of 4-hydrobutyl acrylate. Based on 100 parts by weight of the acrylic resin, 0.05 parts by weight of 1,6-hexanediol diacrylate (a cross-linking agent) and 0.25 parts by weight of Irgacure 651 (an initiator) were added thereto and then, mixed. Subsequently, 1 part by weight of polymer microspheres (920DET40), 7 parts by weight of glass bubbles (K-1), and 0.05 parts by weight of fine powder silica (R-972) as additives were added thereto and then, uniformly mixed. Lastly, 50 parts by weight of the prepared composite flame retardant was added thereto and then, mixed with a mixer to disperse the powder, preparing a composition for an elastic sheet. The composition was coated on a PET film and cured for 10 minutes by using UV coating equipment to manufacture an about 300 μm-thick acryl foam-type elastic sheet.

3. Manufacture of all-Solid-State Rechargeable Battery Cell

85 wt % of LiNi_{0.8}Co_{0.15}Mn_{0.05}O₂ positive electrode active material coated with Li₂O—ZrO₂, 13.5 wt % of a lithium argyrodite-type solid electrolyte Li₆PS₅Cl, 1.0 wt % of a polyvinylidene fluoride binder, and 0.5 wt % of a carbon nanotube conductive material were mixed to prepare a positive electrode composition. The prepared positive electrode composition was coated on an aluminum positive electrode current collector, dried, and compressed to prepare a positive electrode.

A negative electrode coating layer composition was prepared by mixing carbon black having a primary particle diameter (D₅₀) of about 30 nm and silver (Ag) having an average particle diameter (D₅₀) of about 60 nm in a weight ratio of 3:1 to prepare an Ag/C composite and adding 0.25 g of the composite to 2 g of an NMP solution including 7 wt % of a polyvinylidene fluoride binder and then, mixing them. This was coated on a nickel foil current collector using a bar coater and dried in vacuum to prepare a precipitated negative electrode with a negative electrode coating layer formed on the current collector.

An argyrodite-type solid electrolyte Li₆PS₅Cl (D₅₀=3 μm) was added to a binder solution in which an acrylic binder (SX-A334, Zeon) was dissolved in isobutyryl isobutyrate (IBIB) solvent and stirred to prepare a slurry. The slurry included 98.5 wt % of the solid electrolyte and 1.5 wt % of the binder. The slurry was coated on a release PET film using a bar coater and dried at room temperature to prepare a solid electrolyte layer.

Bicell-type cell structures were manufactured by stacking in the order of positive electrode/solid electrolyte/negative electrode/solid electrolyte/positive electrode. The manufactured elastic sheet was interposed between the two cell structures and on the outermost layer of the cell structures. The laminated structure was placed in an aluminum pouch laminate film and subjected to isostatic pressure (WIP) at 500 MPa at 80° C. for 30 minutes to produce an all-solid-state rechargeable battery cell.

### Example 2

A composite flame retardant, an elastic sheet, and an all-solid-state rechargeable battery cell were manufactured substantially in the same method as Example 1 except that the composite flame retardant was prepared by changing the amount of MC to 9 g and the amount of to 21 g to adjust their weight ratio to 7:3.

### Example 3

An elastic sheet was manufactured as follows. The elastic sheet was manufactured as an about 300 μm-thick urethane foam-type by using 35 parts by weight of a propylene polyol having a weight average molecular weight of 4,000 g/mol and 65 parts by weight of a polyether polyol (GP-3000, viscosity (25° C.) of 500 mPa·s, 3 functional groups, a number average molecular weight of 3,000 g/mol) to prepare a resin composition, adding 10 parts by weight of an isocyanate cross-linking agent (Lupranate T80, BASF Corp.) and 35 parts by weight of the composite flame retardant according to Example 1 thereto, stirring the mixture by injecting nitrogen at 100 cc/min for 5 minutes, coating it on a PET film, and heating it at 150° C. Except for using this elastic sheet, an all-solid-state rechargeable battery cell was manufactured substantially in the same method as in Example 1.

### Comparative Example 1

An elastic sheet and an all-solid-state rechargeable battery cell were manufactured substantially in the same manner as in Example 1 except that the elastic sheet was manufactured without using the composite flame retardant of Example 1, and instead adding 50 parts by weight of ADP alone.

### Comparative Example 2

An elastic sheet and an all-solid-state rechargeable battery cell were manufactured substantially in the same manner as in Example 1 except that the elastic sheet was manufactured without using the composite flame retardant of Example 1, and instead adding 40 parts by weight of ADP and 10 parts by weight of MC.

### Comparative Example 3

An elastic sheet and an all-solid-state rechargeable battery cell were manufactured substantially in the same manner as in Example 1 except that the elastic sheet was manufactured without using the composite flame retardant of Example 1, and instead adding 28 parts by weight of ADP and 7 parts by weight of MC.

### Comparative Example 4

An elastic sheet and an all-solid-state rechargeable battery cell were manufactured substantially in the same manner as in Example 1 except that the elastic sheet was manufactured by changing the amount of MC to 12 g and the amount of ADP to 18 g to adjust their weight ratio to 6:4.

### Evaluation Example 1: TGA and FT-IR

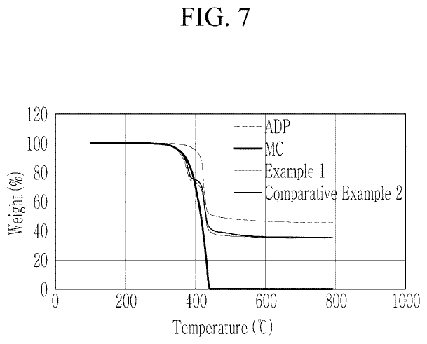

A thermogravimetric analysis (TGA) of the composite flame retardant of Example 1, the flame retardant (ADP+MC) of Comparative Example 2, ADP, and MC was performed, and FIG. 7 shows weight changes according to a temperature. Referring to FIG. 7, the composite flame retardant of Example 1 followed an MC decomposition behavior at 400° C. or less but then, an ADP decomposition behavior at about 400° C. In addition, Comparative Example 2 and Example 1 showed almost similar TGA graphs, but in the composite flame retardant of Example 1, it was confirmed that the ADP surface was surrounded and encapsulated with MC without changing properties of ADP and MC.

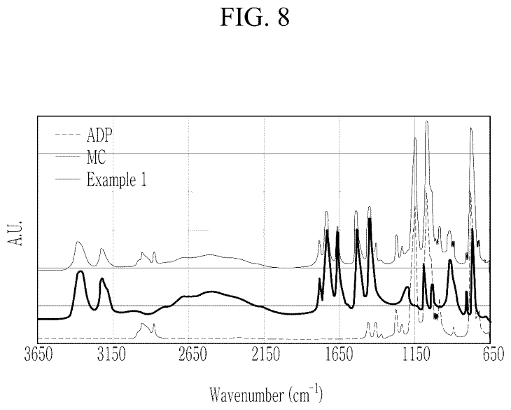

In addition, the composite flame retardant of Example 1, ADP, and MC were respectively analyzed through Fourier infrared spectroscopy (FT-IR), and the results are shown in FIG. 8. Referring to FIG. 8, the composite flame retardant of Example 1 exhibited both a peak of ADP and a peak of MC, which confirmed that two materials were successfully complexed.

### Evaluation Example 2: Evaluation of Flame Retardant Performance and Volatilization Amount

Each of the elastic sheets of Examples 1 to 3 and Comparative Examples 1 to 4 was cut into a size of 200×50 mm to prepare specimens, which were evaluated with respect to flame retardancy by using UL-94 VTM (a thin material vertical burning test), and the results are shown in Table 1. Herein, UL 94 standards may follow flame retardant test standards for plastic materials, UL 94 published by Underwriters Laboratories. The prepared film-type specimens were respectively rolled onto a mandrel with a diameter of 13 mm, taping its upper portion, fixing it with a clamp, twice applying flame to the specimens for 3 seconds to check how the specimens burned and whether a degree of the flame spread to the surroundings.

In addition, the elastic sheets of Examples 1 to 3 and Comparative Examples 1 to 4 were cut into a size of 200×50 mm to prepare specimens for evaluating a volatilization amount, and each of the specimens was measured with respect to a weight and after allowed to stand in a 70° C. oven for 7 days, measured again with respect to a weight, which were used to calculate a weight change to evaluate the volatilization amount, and the results are shown in Table 1.

TABLE 1

| | | | | Comp. | Comp. | Comp. | Comp. |
|---|---|---|---|---|---|---|---|
| | Ex. 1 | Ex. 2 | Ex. 3 | Ex. 1 | Ex. 2 | Ex. 3 | Ex. 4 |
| Elastic | Acrylic | Acrylic | urethane | Acrylic | Acrylic | urethane | Acrylic |
| sheet resin | | | | | | | |
| Flame | ADP:MC | ADP:MC | ADP:MC | ADP | ADP + | ADP + | ADP:MC |
| retardant | (8:2, | (7:3, | (8:2, | alone | MC | MC | (6:4, |
| | capsulation) | capsulation) | capsulation) | 50 parts | (8:2, | (8:2, | capsulation) |
| | 50 parts | 50 parts | 35 parts | by weight | simple | simple | 50 parts |
| | by weight | by weight | by weight | | mixing) | mixing) | by weight |
| | | | | | 50 parts | 35 parts | |
| | | | | | by weight | by weight | |
| Flame | VTM-0 | VTM-0 | VTM-0 | VTM-2 | VTM-1 | VTM-1 | Out-of- |
| retardancy | | | | | | | grade |
| grade | | | | | | | decision |
| Volatilization | 0.51% | 0.65% | 0.44% | 3.60% | 3.21% | 2.80% | 0.67% |
| amount | | | | | | | |

Referring to the flame retardancy grades of Table 1, Examples 1 to 3 achieved a flame retardancy grade VTM-0 and thus realized excellent flame retardant performance. Considering the experiment results of Comparative Examples 1 and 2, compared with using the phosphorus flame retardant alone, using the phosphorus flame retardant with the melamine flame retardant improved the flame retardant performance due to synergistic effects. Comparing Comparative Example 2 with Examples 1 and 2 and also, Comparative Example 3 with Example 3, the encapsulation by coating the melamine flame retardant on the surface of the phosphorus flame retardant through a wet process much more improved the flame retardant performance rather than simply mixing the two flame retardants.

As shown in Example 3, the composite flame retardant was introduced into an urethane resin, and the same flame retardant performance may be said to be achieved by using the flame retardant in a relatively smaller amount than that of the acrylic resin.

On the other hand, Comparative Example 4 exhibited that a ratio of the melamine flame retardant in the composite flame retardant reached a predetermined level or higher, and the flame retardant performance was rather deteriorated. Accordingly, in the flame retardant performance of the composite flame retardant, the phosphorus flame retardant played a major role, and melamine flame retardant played an auxiliary role in improving the flame retardant performance.

Looking at volatilization amounts in Table 1, the phosphorus flame retardant alone was used as shown in Comparative Example 1, and the largest volatilization amount was observed. In addition, the phosphorus flame retardant and the melamine flame retardant were simply mixed as shown in Comparative Example 2, and the volatilization amount was still large. On the contrary, the phosphorus flame retardant was encapsulated with the melamine flame retardant as shown in Examples 1 to 3, and the volatilization amount was overall reduced. The encapsulation of the phosphorus flame retardant with the melamine flame retardant turned out to effectively suppress the volatilization.

### Evaluation Example 3: Compatibility Test of Flame Retardant and Resin

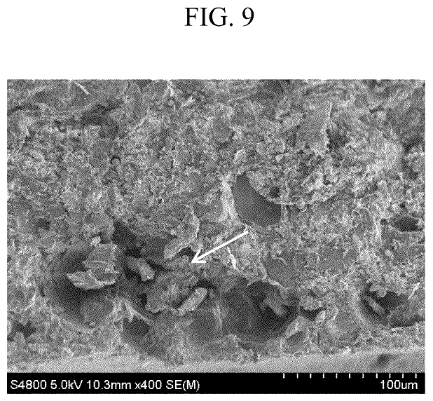

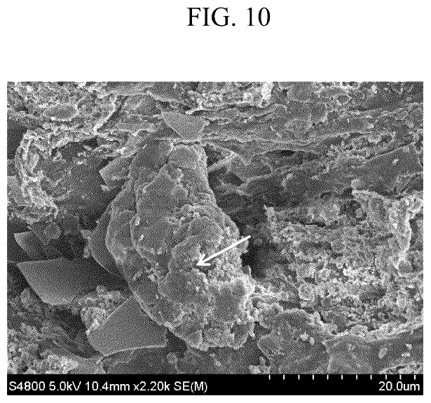

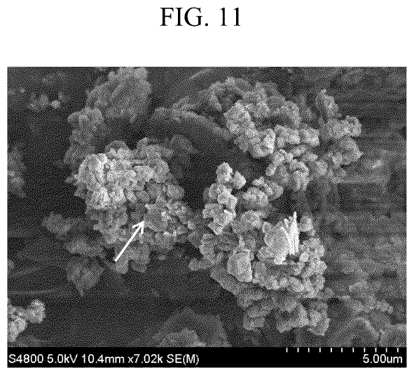

FIGS. 9 to 11 are SEM images showing the cross-section of the elastic sheet manufactured in Comparative Example 2. Referring to a shape indicated by an arrow in FIGS. 9 and 10, compatibility of ADP with an acryl resin was deteriorated, which indicates inferior interfacial characteristics. In addition, referring to a shape indicated by an arrow in FIG. 11, MC agglomerates appeared, which indicates that flame retardant effects were deteriorated.

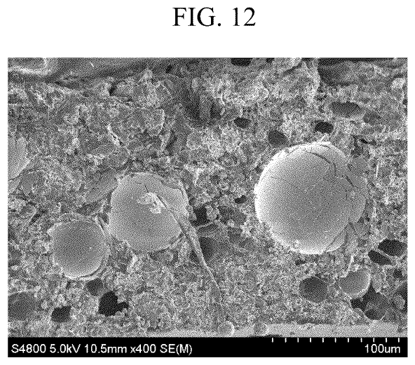

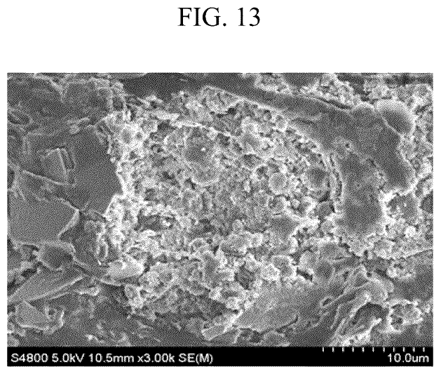

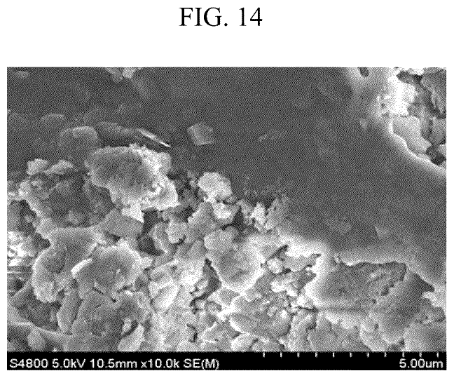

FIGS. 12 to 14 are SEM images showing the cross-section of the elastic sheet manufactured in Example 1. Referring to FIGS. 12 to 14, the phosphorus flame retardant was well bonded with the acryl resin to achieve excellent interfacial characteristics, and in addition, the melamine flame retardant was coated on the surface of the phosphorus flame retardant particles, and the agglomerates were not observed.

By way of summation and review, some commercially available rechargeable lithium batteries may use electrolyte solutions including flammable organic solvents, there are safety issues such as explosion or fire in the event of collision, penetration, and the like. Accordingly, a semi-solid battery or all-solid-state battery that avoids the use of electrolyte solutions has been considered. An all-solid-state battery is a battery in which all materials are solid, e.g., a battery that uses solid electrolytes. This all-solid-state battery has the merit of not being charged as there is no risk of explosion due to electrolyte solution leakage and the like, and that it is easy to manufacture a thin battery.

One or more embodiments may provide a composite flame retardant for an all-solid-state rechargeable battery that can further improve fire safety of all-solid-state rechargeable battery.

The composite flame retardant for an all-solid rechargeable battery according to some embodiments may address issues of flame retardant volatilization, may further improve flame retardant performance due to a synergistic effect of the phosphorus flame retardant and the melamine flame retardant, and may have excellent interfacial characteristics and compatibility with the resin, making it suitable for application to all-solid-state rechargeable batteries.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A composite flame retardant for an all-solid-state rechargeable battery, the composite flame retardant comprising:
core particles including a phosphorus flame retardant; and
a coating layer on a surface of the core particles, the coating layer including a melamine flame retardant,
wherein the coating layer has a thickness of less than or equal to about 1 μm.

2. The composite flame retardant as claimed in claim 1, wherein an average particle diameter (D₅₀) of the core particles is about 5 μm to about 30 μm.

3. The composite flame retardant as claimed in claim 1, wherein the phosphorus flame retardant includes a phosphate, a phosphite, a phosphonate, a phosphinate, a phosphine oxide, or a combination thereof.

4. The composite flame retardant as claimed in claim 1, wherein the phosphorus flame retardant includes ammonium phosphate, ammonium polyphosphate, trimethyl phosphate, triethyl phosphate, tripropyl phosphate, tripentyl phosphate, tris(2-ethylhexyl)phosphate, trioctyl phosphate, tris(2-butoxyethyl) phosphate, tris(2-chloroethyl) phosphate, tris(1-chloro-2-propyl) phosphate, tris(2-chloropropyl) phosphate, tris(3-chloropropyl) phosphate, tris(1,3-dichloro-2-propyl) phosphate, tris(2,3-dibromopropyl) phosphate, tris(tribromoneopentyl) phosphate, trimethylpropane methylphosphinic oligomer, pentaerythritol phosphate, cyclic neopentyl thio phosphoric anhydride, 2-ethylhexyl diphenyl phosphate, isodecyl diphenyl phosphate, dodecyl diphenyl phosphate, triphenyl phosphate, cresyl diphenyl phosphate, tricresyl phosphate, trixylenyl phosphate, xylenyl diphenyl phosphate, tert-butylphenyl diphenyl phosphate, phenyl di(isopropylphenyl) phosphate, tris(2,4-dibromophenyl) phosphate, N,N′-bis(2-hydroxyethyl) aminomethyl phosphate, resorcinol bis(diphenyl phosphate), phenyl diresorcinyl phosphate, bisphenol A bis(diphenyl phosphate), tetraphenyl m-p-phenylene diphosphate, tetrakis(2-chloroethyl)dichloroisopentyl diphosphate, dimethyl propane phosphonate, dimethyl methane phosphonate, diethyl ethane phosphonate, diethyl hydroxymethyl phosphonate, aluminum diethyl phosphinate, zinc diethyl phosphinate, aluminum dipropyl phosphinate, aluminum 2-carboxyethyl phenyl phosphinate, aluminum hypophosphite, or a combination thereof.

5. The composite flame retardant as claimed in claim 1, wherein the coating layer has a thickness of about 10 nm to about 900 nm.

6. The composite flame retardant as claimed in claim 1, wherein the coating layer is in a form of a continuous film or an island.

7. The composite flame retardant as claimed in claim 1, wherein the melamine flame retardant includes melamine, melamine cyanurate, melamine phosphate, melamine pyrophosphate, melamine polyphosphate, or a combination thereof.

8. The composite flame retardant as claimed in claim 1, wherein a ratio of a thickness of the coating layer to a diameter of the core particle is about 0.01 to about 0.1.

9. The composite flame retardant as claimed in claim 1, wherein an average particle diameter (D₅₀) of the composite flame retardant is about 5 μm to about 31 μm.

10. The composite flame retardant as claimed in claim 1, wherein a weight ratio of the phosphorus flame retardant of the core particle and the melamine flame retardant of the coating layer is about 65:35 to about 95:5.

11. A method for preparing a composite flame retardant for an all-solid-state rechargeable battery, the method comprising
mixing a phosphorus flame retardant and a melamine flame retardant in a solvent at a weight ratio of about 65:35 to about 95:5 to prepare a mixture; and
filtering and drying the mixture to obtain a composite flame retardant that includes core particles including a phosphorus flame retardant and a coating layer on a surface of the core particles, the coating layer including a melamine flame retardant.

12. The method as claimed in claim 11, wherein the solvent is an aqueous solvent including water, alcohol, or a combination thereof.

13. The method as claimed in claim 11, wherein mixing the phosphorus flame retardant and the melamine flame retardant in a solvent is performed for about 10 minutes to about 6 hours at a temperature range of about 40° C. to about 120° C.

14. The method as claimed in claim 11, wherein mixing the phosphorus flame retardant and the melamine flame retardant in a solvent includes:
preparing a first solution in which the phosphorus flame retardant is dispersed in a solvent,
preparing a second solution in which a melamine flame retardant is dispersed in a solvent, and
dropping a first solution into the second solution and stirring.

15. The method as claimed in claim 11, wherein the drying is performed in a temperature range of about 80° C. to about 180° C.

16. An elastic sheet for an all-solid-state rechargeable battery, the elastic sheet comprising:
a polymer resin, and
the composite flame retardant as claimed in claim 1.

17. The elastic sheet as claimed in claim 16, wherein the polymer resin includes a urethane resin, an acrylic resin, a silicone resin, a fluorine resin, a copolymer thereof, or a mixture thereof.

18. The elastic sheet as claimed in claim 16, wherein the composite flame retardant is included in an amount of about 1 part by weight to about 60 parts by weight, based on 100 parts by weight of the polymer resin.

19. The elastic sheet as claimed in claim 16, wherein a thickness of the elastic sheet is about 100 μm to about 2,000 μm.

20. The elastic sheet as claimed in claim 16, wherein a thickness of the elastic sheet is about 100 μm to about 300 μm.

21. The elastic sheet as claimed in claim 16, wherein the elastic sheet is in a form of a foam rubber.

22. An all-solid-state rechargeable battery, comprising:
two or more cell structures, each including a positive electrode, a negative electrode, and a solid electrolyte layer between the positive electrode and negative electrode, and
elastic sheets between the two or more cell structures and at an outermost layer,
wherein at least one of the elastic sheets includes the composite flame retardant as claimed in claim 1.

23. An all-solid-state rechargeable battery, comprising:
a cell structure including a positive electrode, a negative electrode, and a solid electrolyte layer between the positive electrode and negative electrode, and
a resin layer on a side of the cell structure,
wherein the resin layer includes a resin and the composite flame retardant as claimed in claim 1.
